(19) United States
(12) Patent Application Publication
(10) Pub. No.: US 2012/0284112 A1
(43) Pub. Date: Nov. 8, 2012

(54) SYSTEMS AND METHODS FOR SOCIAL NETWORK AND LOCATION BASED ADVOCACY WITH NEUROLOGICAL FEEDBACK

(76) Inventors: Anantha Pradeep, Berkeley, CA (US); Ramachandran Gurumoorthy, Berkeley, CA (US); Robert T. Knight, Berkeley, CA (US)

(21) Appl. No.: 13/288,571

(22) Filed: Nov. 3, 2011

Related U.S. Application Data
(60) Provisional application No. 61/409,880, filed on Nov. 3, 2010.

(51) Int. Cl. G06Q 30/02

(52) U.S. Cl. 705/14.41

(57) ABSTRACT

Example methods, systems and tangible machine readable instructions for social network and location based advocacy with neurological feedback are disclosed. An example the method includes detecting a location of a consumer and identifying an advocate in a social network of the consumer. The advocate being a person connected with the consumer in the social network. The example method also includes selecting advocacy material based on the location and the advocate. In addition, the example method includes obtaining neuro-response data from the consumer while or after the consumer is exposed to the advocacy material and determining an effectiveness of the advocacy material based on the neuro-response data.

### RELATED APPLICATION

This patent claims the benefit of U.S. Provisional Patent Application Ser. No. 61/409,880, entitled “Location Aware Advocacy,” which was filed on Nov. 3, 2010, and which is incorporated herein by reference in its entirety.

### FIELD OF THE DISCLOSURE

This disclosure relates generally to advertising, and, more particularly, to systems and methods for social network and location based advocacy with neurological feedback.

### BACKGROUND

Traditional systems and methods for presenting advertising materials are often presented in fixed locations and often contain pre-set or static content.

### BRIEF DESCRIPTION OF THE DRAWINGS

FIG. 1 is a schematic illustration of an example system constructed in accordance with the teachings of this disclosure to provide advocacy materials to a consumer based on neurological information, social network information and location information.

FIGS. 2A-2E are schematic illustrations of an example data collector for use with the example system of FIG. 1.

FIG. 3 is a flow chart representative of example machine readable instructions that may be executed to implement the example system of FIG. 1.

FIG. 4 illustrates an example processor platform that may execute the instructions of FIG. 3 to implement any or all of the example methods, systems and/or apparatus disclosed herein.

### DETAILED DESCRIPTION

Example systems and methods that provide advocacy materials to a consumer based on a location of the consumer (e.g., when the consumer enters the vicinity of a particular product, service, offer, entertainment and/or other location) and at least one advocate in a social network of the consumer are disclosed. Example advocates includes persons connected to the consumer in one of the consumer's social networks such as Facebook, Google+, Myspace, Yelp, Linkedln, Friendster, Flickr, Twitter, Spotify, Bebo, Renren, Weibo, any other online network and/or any non-internet-based network (e.g., friends, relatives, neighbors, etc.). Advocates are persons who the consumer knows and/or may be persons whose opinion the consumer trusts. Example advocacy materials include recommendations, testimonials, coupons, samples, opinions, promotions, advertisements, entertainment, reviews, suggestions, affirmative indications of support (e.g., activating the “like” feature on Facebook) and/or any other material that may be used to support or promote a product, a service, entertainment, a location, a person and/or a thing.

Increasing personalization and targeting in advertisements make such advertisements more topical to consumers, increase the likelihood that the consumer notices and/or observes the advertisement, and increases the likelihood that the consumer is influenced into purchasing the advertised product and/or service. Advertisements relevant to a current location of a consumer may be more interesting to the consumer than advertisements directed to different locations. In addition, advertisements that contain personal information such as, for example, a consumer's name and/or information related to products the consumer has purchased in the past may be more likely to capture the consumer's attention than advertisements that are generically directed to the public in general. However, advertising agencies and their clients typically have only limited knowledge of the targeted consumers including, for example, purchase history and/or any demographic information voluntarily provided by the consumer.

Consumers tend to be strongly influenced by the preferences and habits of their peers. Even the most detailed, targeted and/or personalized advertisement may be less effective at influencing a consumer behavior or purchasing propensity than a recommendation from a trusted peer. Thus, social connections make great advocates in terms of advocating a product and/or service to a consumer. Example methods and systems disclosed herein combine data indicative of a consumer's current location with an advocate in the consumer's social circle or network to select marketing material that would be more likely to be noticed and/or observed by the consumer, and/or more to influence a consumer's behavior and/or purchasing propensity.

In some of the example methods and systems disclosed herein, when a consumer enters or is near a store (e.g., a music store), a sensor or data collector (for example, incorporated into the consumer's mobile phone) detects the consumer's location. Some such example methods and systems access the consumer's social network and determine if there are any people in the social network who have generated any testimonials, recommendations and/or other advocacy materials related to the specific store and/or products sold by the store (e.g., music). Where such an advocate and such advocacy materials are identified, the consumer is presented with an advertisement, display and/or other notice that presents the consumer with the advocacy materials and the name or other identifier of the advocate. For example, the consumer may receive a text message upon entry or approach to a music store that states that Person X (e.g., a friend or a relative in the consumer's social network) highly rates Album Y by Artist Z. Being near the music store and influenced by the social peer, the consumer may be more likely to purchase Album Y. In another example, a consumer's entry into a liquor store is detected and the consumer's social network is searched for appropriate advocates and advocacy material relating to products sold in the liquor store. If relevant materials are identified, the consumer may be presented with the materials such as, for example, via an in-store display or a message on the consumer's own mobile device. Example advocacy materials may include a message that presents a trusted friend's recent Facebook status update, such as “Tom is enjoying a Manhattan with cherries this warm summer evening,” and the consumer is presented with a coupon for Maker's Mark® bourbon to influence the consumer to purchase Maker's Mark® bourbon.

An example method to determine the effectiveness of the advocacy materials is to track a consumer's purchase history. However, the purchase history may not always accurately indicate an effectiveness of the advocacy materials. For example, if the consumer in the example above drove to the liquor store with the intent on purchasing Marker's Mark® bourbon, the advocacy materials may have been duplicative, only minorly influenced the consumer and/or had no effect. To more accurately determine the effectiveness of marketing materials, some of the example methods and systems disclosed herein, neurological response data is gathered from the consumer. Example neuro-response data includes brain wave activity in the form of electroencephalography data measured by surface electrodes. Other examples of neuro-response data and data collection mechanisms are disclosed below. In some examples, electroencephalography data includes data from a first brain wave frequency and data from a second brain wave frequency, which may be analyzed (e.g., combined, computed, correlated, etc.) to determine an interaction therebetween. The neuro-response data is indicative of attention, emotion and/or memory retention. In some examples, such data is used to determine, for example, if the consumer had a positive reaction to the advocacy materials. For example, if the brain wave activity indicates that the consumer is alert and has high memory retention activity while or shortly after being exposed to the advocacy material, example systems and methods may determine that the advocacy materials were effective. In addition, in some examples, the advocacy material(s) may be tagged and/or stored as effective for future use with the consumer and/or other consumers. In some examples in which the advocacy materials were not effective, the example systems and methods change the advocacy materials, for example in real time or near real time, to identify, select and/or present additional and/or alternative advocacy materials to influence the consumer's behavior and/or purchase propensity.

In some examples, the advocates are compensated for production of the advocacy materials. For example, the advocates may receive monetary compensation for providing advocacy materials that were determined to be effective. In other examples, the compensation may be in the form of virtual coins or credits that may be used in the social network environment (for example, for playing games). In some examples, the amount of compensation may be ties to the effectiveness of the advocacy materials. For example, where the advocacy was not effective, the advocate may be compensated at a reduced rate or receive no compensation for his or her advocacy.

Example methods to provide advocacy materials to a consumer disclosed herein include detecting a location of a consumer and identifying an advocate in a social network of the consumer, the advocate being a person the consumer knows, trusts and/or is otherwise connected with in the social network. Some such example methods also include selecting an advocacy material based on the location and the advocate. In addition, example methods include obtaining neuro-response data from the consumer while or after the consumer is exposed to the advocacy material and determining an effectiveness of the advocacy material based on the neuro-response data.

Some example methods to provide advocacy materials to a consumer disclosed herein include detecting a location of a consumer, obtaining neuro-response data from the consumer and identifying an advocate in a social network of the consumer. In this example, the advocate is a person connected with the consumer in the social network. The example method also includes selecting advocacy material based on the neuro-response data, the location and the advocate.

In some example(s), the advocacy material is changed based on the neuro-response data. In some example(s), changing the advocacy material includes selecting a new advocate from the social network and new advocacy materials associated with the new advocate.

In some of the disclosed example(s), the advocacy material is one or more of an advertisement, an offer, a coupon, a product package, a display, a sign, a recommendation, a testimonial, a quote, a statement posted on a social network internet site and/or a review.

In some disclosed example(s), the neuro-response data includes one or more of electroencephalography data, functional magnetic resonance imaging data, galvanic skin response data, magnetic electroencephalography data, electrocardiogram data, pupillary dilation data, eye tracking data, facial emotion encoding data and/or reaction time data. In some example(s), the neuro-response data is indicative of one or more of alertness, engagement, attention or resonance. In some example(s), the neuro-response data comprises data from a first frequency band of a brain of the consumer and data from a second frequency band different than the first frequency band. In some examples, the neuro-response data is indicative of an interaction between the first and second frequency band. In some example methods, the location is detected using one or more of a global positioning system, a wireless internet location service, cellular triangulation and/or manual entry.

In some example(s), the advocate is compensated based on the effectiveness of the advocacy material(s).

In some example(s), the neuro-response data is obtained through a mobile device. In some such example(s), the mobile device is one or more of a mobile telephone or a headset with a plurality of electrodes.

In some example(s), the advocacy material is changed based on a change in the geographic location. Also, in some example(s), the change occurs in real time.

An example system to provide advocacy materials to a consumer disclosed herein includes a sensor to detect a geographic location of a consumer and a selector to identify an advocate (e.g., a person, a friend, a relative, a neighbor, an acquaintance, etc.) in a social network of the consumer. In some examples, the advocate may be a person who is not personally known but who is or can be trusted including, for example, a highly connected person with whom the consumer shares a lot of connections, a person from the consumer's neighborhood, a distant relative, etc. The example selector selects an advocacy material based on the location and the advocate. The example system also includes a data collector to obtain neuro-response data from the consumer while or after the consumer is exposed to the advocacy material and a data analyzer to determine an effectiveness of the advocacy material based on the neuro-response data.

In some example(s) the selector changes the advocacy material based on the neuro-response data, selects a new advocate from the social network to change the advocacy material, changes the advocacy material based on a change in the location and/or changes the advocacy material in real time.

In some example(s), the sensor is associated with and/or uses one or more of a global positioning system, a wireless internet location service, cellular triangulation, radio frequency identification tags, infrared technology, and/or manual entry to determine the geographic location of the consumer. Also, in some example(s), the sensor is commensurate with and/or incorporated within a mobile device including one or more of a mobile telephone or a headset with a plurality of electrodes.

Some example(s) include an accounting tracker to compensate the advocate based on the effectiveness of the advocacy material(s).

Example tangible machine readable medium storing instructions are disclosed herein. The example instructions, when executed, cause a machine to at least detect a location of a consumer and identify an advocate in a social network of the consumer. The example instructions also cause the machine to select advocacy material based on the location and the advocate. In addition, the example instructions cause the machine to obtain neuro-response data from the consumer while or after the consumer is exposed to the advocacy material and to determine an effectiveness of the advocacy material based on the neuro-response data.

In some example(s) the instructions cause the machine to change the advocacy material based on the neuro-response data, to select a new advocate from the social network to change the advocacy material, to change the advocacy material based on a change in the location, and/or to change the advocacy material in real time.

In some example(s), the instructions cause the machine to use one or more of a global positioning system, a wireless internet location service, cellular triangulation and/or manual entry to detect the location of the consumer.

In some example(s), the instructions cause the machine to compensate the advocate based on the effectiveness.

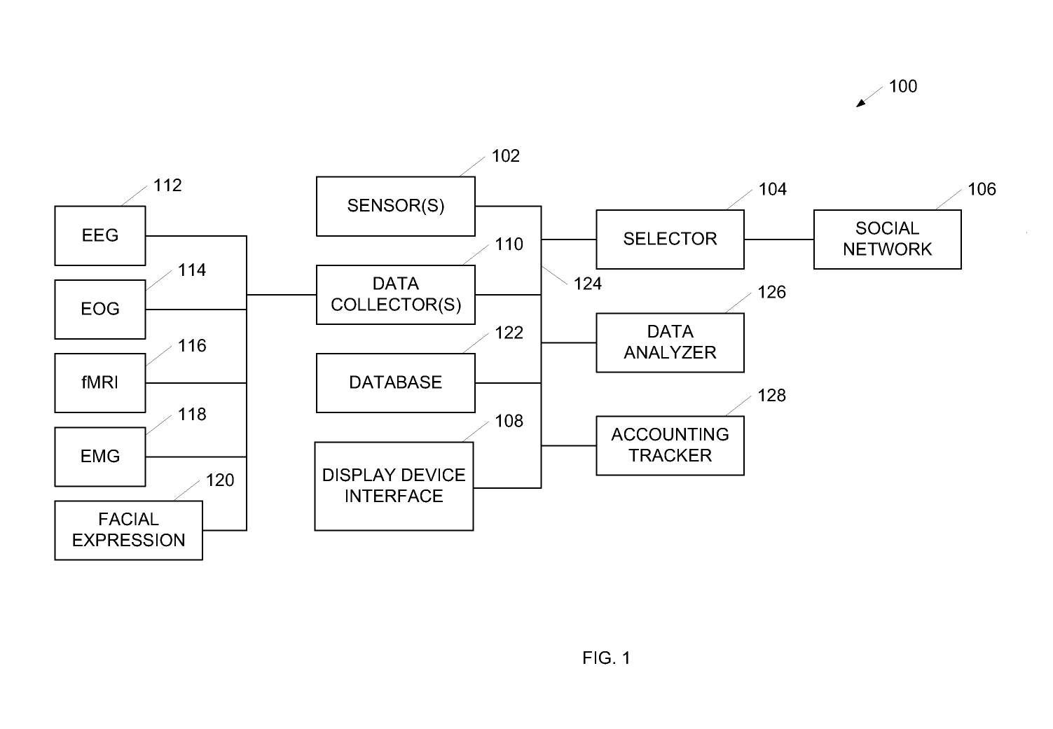

FIG. 1 illustrates an example system 100 that may be used to match and/or provide a consumer with advocacy material(s). The example system 100 includes one or more sensor(s) 102 that detect a geographic location of a consumer. In some examples the sensor(s) are integrated with or otherwise communicatively coupled to a global positioning system and/or a wireless internet location service, which are used to determine the location of the consumer. Also, in some examples, cellular triangulation is used to determine the location. In other examples, the consumer is requested to manually indicate his or her location. In some examples, the sensor(s) are integral to a mobile device such as, for example, a mobile telephone, an audience measurement device, an ear piece, and/or a headset with a plurality of electrodes such as, for example, dry surface electrodes. The sensor(s) 102 may continually track the consumer's movements, may be activated at discrete locations, may be periodically activated and/or may be activated aperiodically.

The example system 100 of FIG. 1 also includes a selector 104 that is communicatively coupled to a social network 106 of which the consumer is a member. For example, the selector 104 may have access to a list of contacts in a consumer's social network, may have access to recent activity of the consumer, and/or may have access to one or more of the contacts. The selector of the illustrated example identifies an advocate in the social network of the consumer. An advocate is a person the consumer knows and/or trusts. For example, the selector may identify an advocate based on the frequency of interactions between the consumer and the potential advocate. Additionally or alternatively, the advocate may be chosen based on the relationship between the advocate and the consumer such as, for example, spouses, parent-child, siblings, friends, colleagues, etc. The relationships may be ordered in a hierarchical fashion so that persons in a first level that are more likely to influence the consumer are used first, if available; persons in the second level are selected as advocates if none of the persons in the first level are selected, etc. Further still, the advocate may be identified based on similarities with the consumer including similarities in demographics, location, stated or observed preferences, network activity and/or network connections. Alternatively or additionally, users may be selected as advocates based on a record of success in influencing the consumer or consumers of similar demographics. In these examples, the advocate is a trusted person whose opinion would be respected by the consumer.

The example selector 104 also selects advocacy material(s) based on the location and the advocate. For example, the consumer may receive a recommendation or testimonial from one of the identified advocates about a service at a mall store that the consumer is walking towards. In another example, the consumer may indicate in his social network profile that he is interested in exercise equipment, and the consumer may be presented with a testimonial from an advocate about a gym. In other examples, the consumer may indicate that he is interested in time saving services and a recommendation from one of the members of the consumer's social network for a service (e.g., a service that picks up and delivers dry cleaning) is presented to the consumer. The advocacy material(s) may take many forms including one or more of a recommendation, a testimonial, a suggestion, a warning, an affirmation of approval (e.g., activation of Facebook's “like” feature), a quote, a star rating, average ratings from members of the social network, a coupon, an offer, a sample and/or any other suitable promotion. In some examples the advocacy material(s) are received from multiple advocates, vendors, companies, firms, etc., and maintained in the database 122. In some examples, the advocate validates or otherwise signals approval of the advocacy material provided by others (e.g., companies). For example, the advocate may indicate that he or she agrees with statements that appear in a corporate-produced material and/or may indicate that he or she likes a particular advertisement, advertising campaign, product appearance, etc. In some examples, the advocacy material(s) are based in ethnography or affinity group(s) related to the consumer.

The example system 100 of FIG. 1 includes a display device interface 108 that the system 100 uses to communicate the advocacy materials to a display or other presentation device for presentation to the consumer. In some example(s), the display device interface 108 is communicatively coupled to a mobile device (e.g., a mobile phone) of the consumer to present the advocacy material(s) to the consumer through a screen and/or speakers of the mobile device. In other examples, the presentation display is a display near the consumer such as, for example, an in-store television, a kiosk, a shelf display, a display integrated into a shopping cart or shopping basket, a presentation device provided with an electroencephalography headset, a printout, a car stereo system, an in-home television, a billboard and/or other suitable device for communicating with the consumer.

The example system 100 of FIG. 1 also includes one or more data collector(s) 110 to obtain neuro-response data from the consumer while or after the consumer is exposed to the advocacy material. In some example(s) the data collector(s) 110 and the sensor(s) are integrated. The example data collector 110 may include, for example, one or more electrode(s), camera(s) and/or other sensor(s) to gather any type(s) of neurological and/or physiological data, including, for example, functional magnetic resonance (fMRI) data, electroencephalography (EEG) data, magnetoencephalography (MEG) data and/or optical imaging data. The data collector(s) 110 of the illustrated example may gather data continuously, periodically or aperiodically.

The data collector(s) 110 of the illustrated example gather neurological and/or physiological measurements such as, for example, central nervous system measurements, autonomic nervous system measurement(s) and/or effector measurement(s), which may be used to evaluate a consumer's reaction(s) and/or impression(s) of one or more advocacy material(s). Some examples of central nervous system measurement mechanisms that are employed in some examples detailed herein include fMRI, EEG, MEG and optical imaging. Optical imaging may be used to measure the absorption or scattering of light related to concentration of chemicals in the brain or neurons associated with neuronal firing. MEG measures magnetic fields produced by electrical activity in the brain. fMRI measures blood oxygenation in the brain that correlates with increased neural activity.

EEG measures electrical activity resulting from thousands of simultaneous neural processes associated with different portions of the brain. EEG also measures electrical activity associated with post synaptic currents occurring in the milliseconds range. Subcranial EEG can measure electrical activity with high accuracy. Although bone and dermal layers of a human head tend to weaken transmission of a wide range of frequencies, surface EEG provides a wealth of useful electrophysiological information. In addition, portable EEG with dry electrodes also provides a large amount of useful neuro-response information.

EEG data can be classified in various frequency bands. Brainwave frequency bands include delta, theta, alpha, beta, and gamma frequency ranges. Delta waves are classified as those less than 4 Hz and are prominent during deep sleep. Theta waves have frequencies between 3.5 to 7.5 Hz and are associated with memories, attention, emotions, and sensations. Theta waves are typically prominent during states of internal focus. Alpha frequencies reside between 7.5 and 13 Hz and typically peak around 10 Hz. Alpha waves are prominent during states of relaxation. Beta waves have a frequency range between 14 and 30 Hz. Beta waves are prominent during states of motor control, long range synchronization between brain areas, analytical problem solving, judgment, and decision making. Gamma waves occur between 30 and 60 Hz and are involved in binding different populations of neurons together into a network for the purpose of carrying out a certain cognitive or motor function, as well as in attention and memory. Because the skull and dermal layers attenuate waves above 75-80 Hz, brain waves above this range may be difficult to detect. Nonetheless, in some of the disclosed examples, high gamma band (kappa-band: above 60 Hz) measurements are analyzed, in addition to theta, alpha, beta, and low gamma band measurements to determine a consumer's reaction(s) and/or impression(s) (such as, for example, attention, emotional engagement and/or memory). In some examples, high gamma waves (kappa-band) above 80 Hz (detectable with sub-cranial EEG and/or MEG) are used in inverse model-based enhancement of the frequency responses indicative of a consumer's reaction(s) and/or impression(s). Also, in some examples, consumer and task specific signature sub-bands (i.e., a subset of the frequencies in a particular band) in the theta, alpha, beta, gamma and/or kappa bands are identified to estimate a consumer's reaction(s) and/or impression(s). Particular sub-bands within each frequency range have particular prominence during certain activities. In some examples, multiple sub-bands within the different bands are selected for analysis while remaining frequencies are blocked via band pass filtering. In some examples, multiple sub-band responses are enhanced, while the remaining frequency responses may be attenuated.

Interactions between frequency bands are demonstrative of specific brain functions. For example, a brain processes the communication signals that it can detect. A higher frequency band may drown out or obscure a lower frequency band. Likewise, a high amplitude may drown out a band with low amplitude. Constructive and destructive interference may also obscure bands based on their phase relationship. In some examples, the neuro-response data may capture activity in different frequency bands and determine that a first band may be out of a phase with a second band to enable both bands to be detected. Such out of phase waves in two different frequency bands are indicative of a particular communication, action, emotion, thought, etc. In some examples, one frequency band is active while another frequency band is inactive, which enables the brain to detect the active band. A circumstance in which one band is active and a second, different band is inactive is indicative of a particular communication, action, emotion, thought, etc. For example, neuro-response data showing increasing theta band activity occurring simultaneously with decreasing alpha band activity provides a measure that internal focus is increasing (theta) while relaxation is decreasing (alpha), which together suggest that the consumer is actively processing the stimulus (e.g., the advocacy material).

Autonomic nervous system measurement mechanisms that are employed in some examples disclosed herein include electrocardiograms (EKG) and pupillary dilation, etc. Effector measurement mechanisms that are employed in some examples disclosed herein include electrooculography (EOG), eye tracking, facial emotion encoding, reaction time, etc. Also, in some examples, the data collector(s) 110 collect other type(s) of central nervous system data, autonomic nervous system data, effector data and/or other neuro-response data. The example collected neuro-response data may be indicative of one or more of alertness, engagement, attention, memory, and/or resonance.

In the illustrated example, the data collector(s) 110 collect neurological and/or physiological data from multiple sources and/or modalities. In the illustrated, the data collector(s) 110 include components to gather EEG data 112 (e.g., scalp level electrodes), components to gather EOG data 114 (e.g., shielded electrodes), components to gather fMRI data 116 (e.g., a differential measurement system, components to gather EMG data 118 to measure facial muscular movement (e.g., shielded electrodes placed at specific locations on the face) and components to gather facial expression data 120 (e.g., a video analyzer). The data collector(s) 110 may also include one or more additional sensor(s) to gather data related to any other modality including, for example, GSR data, MEG data, EKG data, pupillary dilation data, eye tracking data, facial emotion encoding data and/or reaction time data. Other example sensors include cameras, microphones, motion detectors, gyroscopes, temperature sensors, etc., which may be integrated with or coupled to the data collector(s) 110 and/or the sensor(s) 102.

In some examples, only a single data collector 110 is used. In other examples a plurality of data collectors 110 are used. Data collection is performed automatically in the example of FIG. 1. In addition, in some examples, the data collected is digitally sampled and stored for later analysis such as, for example, in the database 122. In some examples, the data collected is analyzed in real-time. According to some examples, the digital sampling rates are adaptively chosen based on the type(s) of physiological, neurophysiological and/or neurological data being measured.

In the example system 100 of FIG. 1, the data collector(s) 110 are communicatively coupled to other components of the example system 100 via communication links 124. The communication links 124 may be any type of wired (e.g., a databus, a USB connection, etc.) or wireless communication mechanism (e.g., radio frequency, infrared, etc.) using any past, present or future communication protocol (e.g., Bluetooth, USB 2.0, etc.). Also, the components of the example system 100 may be integrated in one device or distributed over two or more devices.

The illustrated example system 100 of FIG. 1 includes an analyzer 126. The example analyzer 126 receives the data gathered from the data collector(s) 110 and analyzes the data for trends, patterns and/or relationships. The analyzer 126 of the illustrated example reviews data within a particular modality (e.g., EEG data) and between two or more modalities (e.g., EEG data and eye tracking data). Thus, the analyzer 126 of the illustrated example provides an assessment of intra-modality measurements and cross-modality measurements.

With respect to intra-modality measurement enhancements, in some examples, brain activity is measured to determine regions of activity and to determine interactions and/or types of interactions between various brain regions. Interactions between brain regions support orchestrated and organized behavior. Attention, emotion, memory, and other abilities are not based on one part of the brain but instead rely on network interactions between brain regions. Thus, measuring signals in different regions of the brain and timing patterns between such regions provide data from which attention, emotion, memory and/or other neurological states can be recognized. In addition, different frequency bands used for multi-regional communication may be indicative of a consumer's reaction(s) and/or impression(s) (e.g., a level of alertness, attentiveness and/or engagement). Thus, data collection using an individual collection modality such as, for example, EEG is enhanced by collecting data representing neural region communication pathways (e.g., between different brain regions) in different frequency bands. Such data may be used to draw reliable conclusions of a consumer's reaction(s) and/or impression(s) (e.g., engagement level, alertness level, etc.) and, thus, to provide the bases for determining if advocacy material(s) were effective. For example, if a consumer's EEG data shows high theta band activity at the same time as high gamma band activity, both of which are indicative of memory activity, an estimation may be made that the consumer's reaction(s) and/or impression(s) is one of alertness, attentiveness and engagement.

With respect to cross-modality measurement enhancements, in some examples, multiple modalities to measure biometric, neurological and/or physiological data is used including, for example, EEG, GSR, EKG, pupillary dilation, EOG, eye tracking, facial emotion encoding, reaction time and/or other suitable biometric, neurological and/or physiological data. Thus, data collected using two or more data collection modalities may be combined and/or analyzed together to draw reliable conclusions on consumer states (e.g., engagement level, attention level, etc.). For example, activity in some modalities occurs in sequence, simultaneously and/or in some relation with activity in other modalities. Thus, information from one modality may be used to enhance or corroborate data from another modality. For example, an EEG response will often occur hundreds of milliseconds before a facial emotion measurement changes. Thus, a facial emotion encoding measurement may be used to enhance an EEG emotional engagement measure. Also, in some examples EOG and eye tracking are enhanced by measuring the presence of lambda waves (a neurophysiological index of saccade effectiveness) in the EEG data in the occipital and extra striate regions of the brain, triggered by the slope of saccade-onset to estimate the significance of the EOG and eye tracking measures. In some examples, specific EEG signatures of activity such as slow potential shifts and/or measures of coherence in time-frequency responses at the Frontal Eye Field (FEF) regions of the brain that preceded saccade-onset are measured to enhance the effectiveness of the saccadic activity data. Some such cross modality analyses employ a synthesis and/or analytical blending of central nervous system, autonomic nervous system and/or effector signatures. Data synthesis and/or analysis by mechanisms such as, for example, time and/or phase shifting, correlating and/or validating intra-modal determinations with data collection from other data collection modalities allow for the generation of a composite output characterizing the significance of various data responses and, thus, the classification of attributes of a property and/or representative based on a consumer's reaction(s) and/or impression(s).

In some examples, actual expressed responses (e.g., survey data) and/or actions for one or more consumer(s) or group(s) of consumers may be integrated with biometric, neurological and/or physiological data and stored in the database or repository 122 in connection with one or more advocacy material(s). In some examples, the actual expressed responses may include, for example, a consumer's stated reaction and/or impression and/or demographic and/or preference information such as an age, a gender, an income level, a location, interests, buying preferences, hobbies and/or any other relevant information. The actual expressed responses may be combined with the neurological and/or physiological data to verify the accuracy of the neurological and/or physiological data, to adjust the neurological and/or physiological data and/or to determine the effectiveness of the advocacy material(s). For example, a consumer may provide a survey response that details why a purchase was made. The survey response can be used to validate neurological and/or physiological response data that indicated that the consumer was engaged and memory retention activity was high.

In some example(s), the selector 104 of the example system 100 changes the advocacy material based on detected effectiveness of the same. For example, if the data analyzer 126 determines that first presented advocacy material is not effective (e.g., the neuro-response data indicated that the consumer was disengaged and/or otherwise not attentive to the advocacy material), different advocacy material may be presented to the consumer. Different advocacy material may be obtained from the advocate associated with the first advocacy material and/or the selector 104 may identify a different advocate.

In some example(s), the selector 104 changes the advocacy material based on a change in the location. For example, if the consumer is travelling and moves to a second location near or in a different store, different advocacy materials may be more relevant. For example, if the consumer in the above example leaves the music store and enters a pharmacy or drug store, the example sensor 102 detects the new location, and the example selector 104 identifies an advocate and advocacy material relevant to the consumer's new location such as, for example, a testimonial from a Facebook friend raving about a buy-one/get-one free sale on laundry detergent at the drugstore. In some examples, a sequence of locations or a path of a consumer is detected and the advocacy materials are selected based on the consumer's path and or projected path.

The example system 100 of FIG. 1 also includes an accounting tracker 128 to calculate a compensation for the advocate. For example, the advocate may be paid or rewarded based on the effectiveness of the advocacy material(s) and/or the compensation may be based on purchases or transactions resulting from the advocacy.

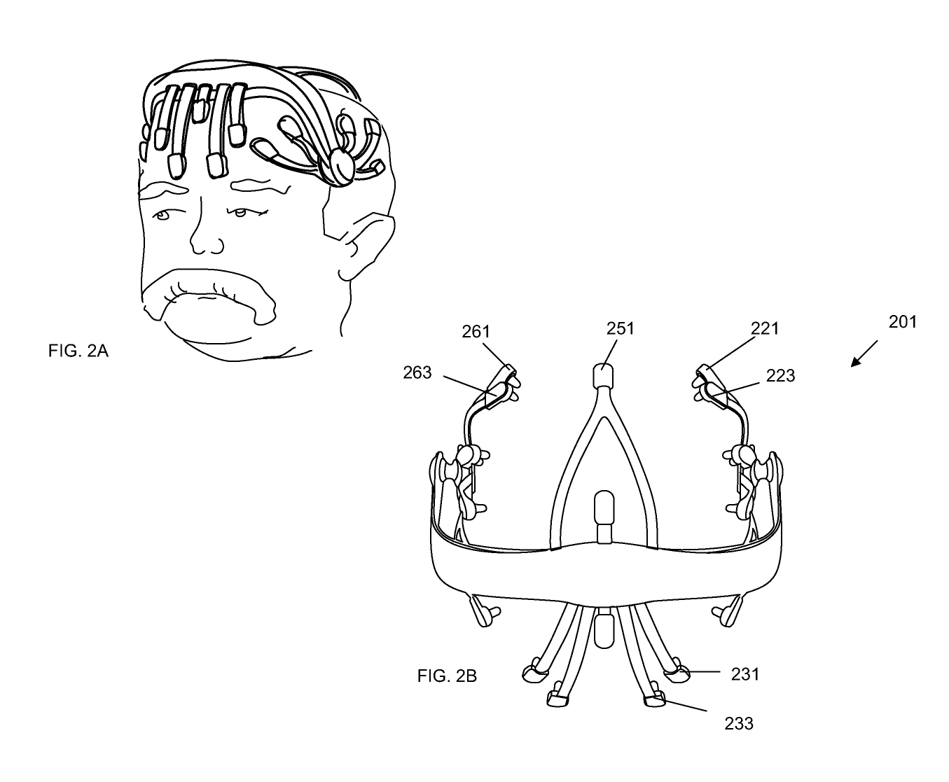

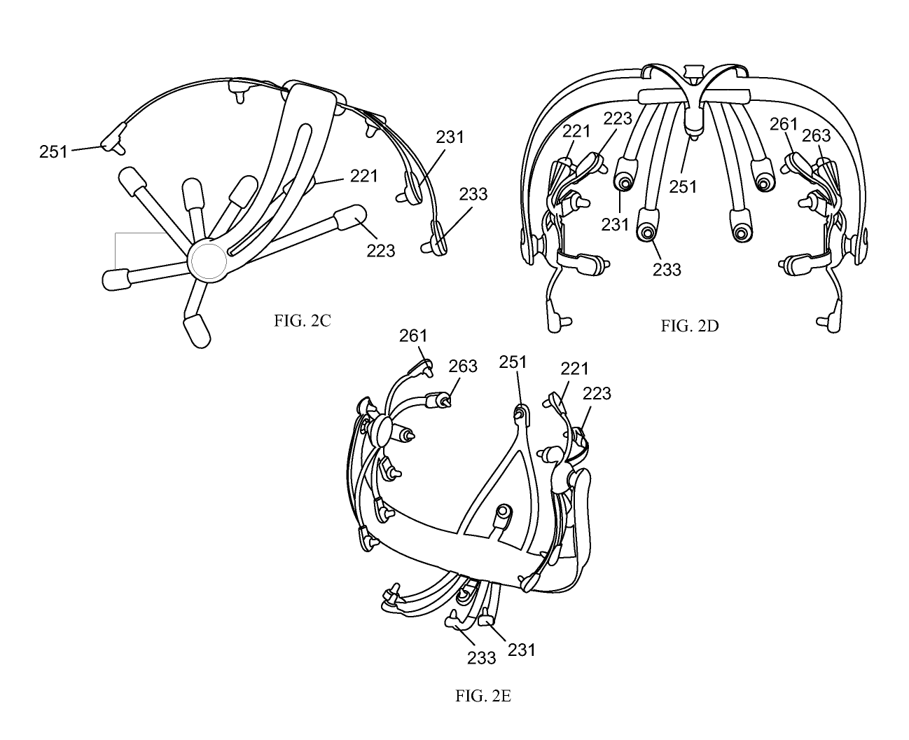

FIGS. 2A-2E illustrate an example data collector 201, which in this example, collects neurological data. FIG. 2A shows a perspective view of the data collector 201 including multiple dry electrodes. In the illustrated example, the data collector 201 is a headset having point or teeth, dry electrodes to contact the scalp through human hair without the use of electro-conductive gels. In some examples, the signal collected by each electrode is individually amplified and isolated to enhance shielding, routability and/or to associated particular signals with particular regions of the brain. In some examples, each electrode has an associated amplifier implemented using a flexible printed circuit. In the illustrated example, signals are routed to a controller/processor for immediate analysis by a data analyzer or stored for later analysis. The controller/processor may be used to synchronize present data on a consumer device based on the data collected. The data collector 201 of the illustrated example has transmitters for transmitting data to a remote entity such as a data analyzer. The data collector 201 of the illustrated example may time stamp the data it collects based on a clock signal developed on the data collector 201 and/or received from an external device.

FIGS. 2B-2E illustrate top, side, rear, and perspective views of the example data collector 201 of FIG. 2A. The data collector 201 of the illustrated example includes multiple dry electrodes including right side electrodes 261 and 263, left side electrodes 221 and 223, front electrodes 231 and 233, and rear electrode 251. The specific electrode arrangement is different in other examples. In the illustrated example, the placing of electrodes on the temporal region of the head is avoided to prevent collection of signals generated based on muscle contractions. Avoiding contact with the temporal region also enhances comfort during sustained wear.

In some examples, forces applied by the electrodes 221 and 223 counterbalance forces applied by the electrodes 261 and 263, and forces applied by the electrodes 231 and 233 counterbalance forces applied by electrode 251. Also, in some examples, the EEG dry electrodes detect neurological activity with little or no interference from human hair and without use of any electrically conductive gels. Also, in some examples, the data collector 201 includes EOG sensors to detect eye movements.

In some examples, data acquisition using the electrodes 221, 223, 231, 233, 251, 261, and 263 is synchronized with changes detected by and/or in a consumer device such as, for example, changes in a geographic location and/or changes in a consumer interface. Data acquisition can be synchronized with the changes detected by and/or in the consumer device by using a shared clock signal. The shared clock signal may originate from the data collector 201, the consumer device, a headset, a cell tower, a satellite, etc. The data collector 201 of the illustrated example also includes a transmitter and/or receiver (e.g., a transceiver) to send collected data to a data analysis system and to receive clock signals as needed. In some examples, a transceiver transmits all collected data such as biometric data, neurological data, physiological data, consumer state and/or sensor data to a data analyzer. In other examples, a transceiver transmits only select data output by a filter.

In some examples, the transceiver is coupled to a computer system that transmits data over a wide area network to a data analyzer. In other examples, the transceiver directly sends data to a local data analyzer. Other collectors such as fMRI and/or MEG collectors that are not yet portable but may become portable at some future time may also be integrated into the example headset of FIG. 2A.

In the illustrated example, the data collector 201 includes a battery to power components such as amplifiers and/or transceivers. In the illustrated example, the transceiver includes an antenna. In some examples, some of the above described components are excluded. For example, filters or storage may be excluded from the example headset 201 to reduce weight, bulk and/or cost.

While example manners of implementing the example system 100 to match or provide advocacy material(s) to a consumer and the example data collector 201 have been illustrated in FIGS. 1 and 2A-E, one or more of the elements, processes and/or devices illustrated in FIGS. 1 and 2A-E may be combined, divided, re-arranged, omitted, eliminated and/or implemented in any other way. Further, the example sensor 102, the example selector 104, the example display device interface 108, the example data collector 110, the example data collector 201 the example database 122, the example data analyzer 126 and/or the example accounting module 128 and/or, more generally, the example system 100 of FIG. 1 may be implemented by hardware, software, firmware and/or any combination of hardware, software and/or firmware. Thus, for example, the example sensor 102, the example selector 104, the example display device interface 108, the example data collector 110, the example data collector 201, the example database 122, the example data analyzer 126 and/or the example accounting tracker 128 and/or, more generally, the example system 100 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example sensor 102, the example selector 104, the example display device interface 108, the example data collector 110, the example data collector 201, the example database 122, the example data analyzer 126 and/or the example accounting module 128 are hereby expressly defined to include hardware and/or a tangible computer readable medium such as a memory, DVD, CD, etc. storing the software and/or firmware. Further still, the example system 100 of FIG. 1 may include one or more elements, processes and/or devices in addition to, or instead of, those illustrated in FIG. 1, and/or may include more than one of any or all of the illustrated elements, processes and devices.

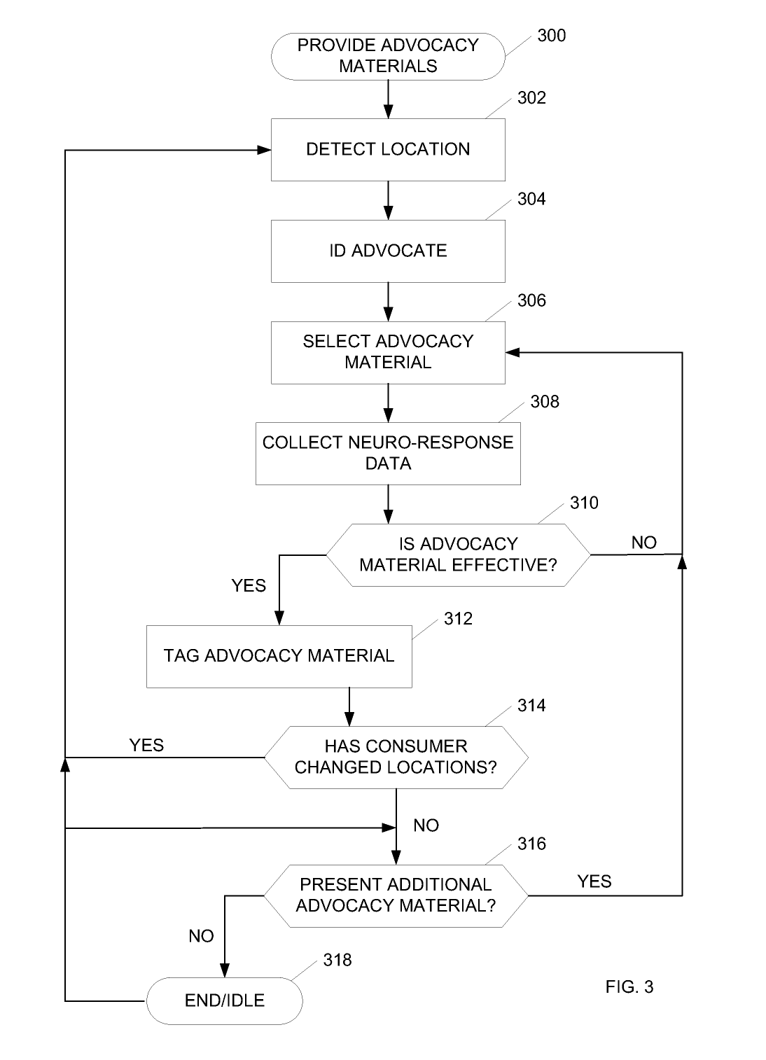

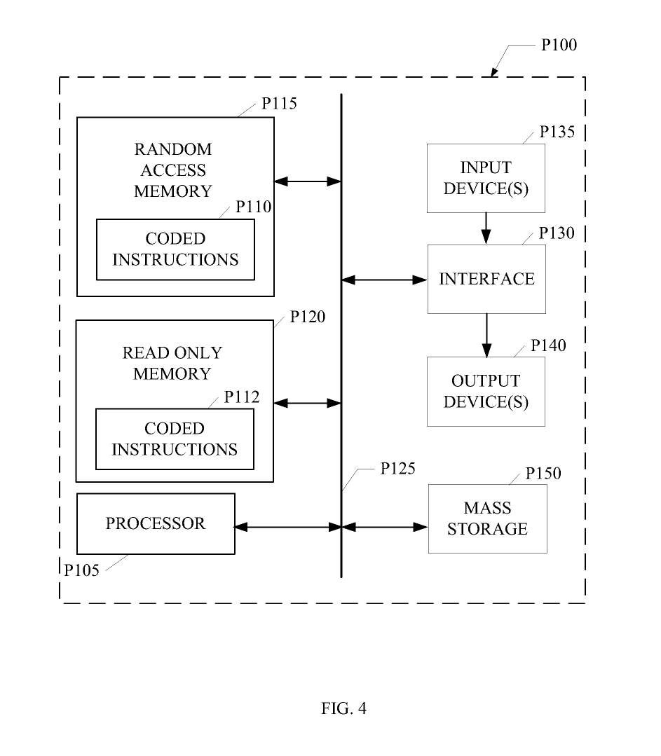

FIG. 3 is a flowchart representative of example machine readable instructions that may be executed to implement the example system 100, the example sensor 102, the example selector 104, the example display device interface 108, the example data collector 110, the example data collector 201, the example database 122, the example data analyzer 126, the example accounting tracker 128 and/or other components of FIGS. 1 and 2A-E. In the example of FIG. 3, the machine readable instructions include a program for execution by a processor such as the processor P105 shown in the example computer P100 discussed below in connection with FIG. 4. The program may be embodied in software stored on a tangible computer readable medium such as a CD-ROM, a floppy disk, a hard drive, a digital versatile disk (DVD), or a memory associated with the processor P105, but the entire program and/or parts thereof could alternatively be executed by a device other than the processor P105 and/or embodied in firmware or dedicated hardware. Further, although the example program is described with reference to the flowchart illustrated in FIG. 3, many other methods of implementing the example system 100, the example sensor 102, the example selector 104, the example display device interface 108, the example data collector 110, the example data collector 201, the example database 122, the example data analyzer 126, the example accounting tracker 128, and/or the other components of FIGS. 1 and/or 2A-E may alternatively be used. For example, the order of execution of the blocks may be changed, and/or some of the blocks described may be changed, eliminated, or combined.

As mentioned above, the example processes of FIG. 3 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 3 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 3 illustrates an example process to match or provide advocacy material(s) to a consumer. The example process 300 of FIG. 3 includes detecting a location of a consumer (block 302) using, for example, the sensor(s) 102 of FIG. 1. The example process also includes identifying an advocate (block 304). The advocate is a person connected to the consumer in a social network of the consumer. For example, the advocate may be one of the consumer's friends on a social network internet site such as, for example Facebook, or any other person connected to the consumer in a network. The example method 300 also selects advocacy material (block 306) for presentation to the consumer. In examples disclosed herein, the advocacy material is selected based on the consumer's location and the advocate. For example, a consumer in a grocery store may be presented with a recommendation from a friend that advocates a particular recipe.

In the illustrated example of FIG. 3, the example method 300 also collects neuro-response data (block 308) using, for example, the data collector(s) 110 of FIG. 1 and/or the data collector 201 of FIGS. 2A-E. In the illustrated example, the neuro-response data is collected while or shortly after the consumer is exposed to the advocacy material. The neuro-response data is analyzed (for example, with the data analyzer 126 of FIG. 1) to determine if the advocacy material was effective (block 310). If the advocacy material was not effective, additional/alternative advocacy material is selected (block 306). If the advocacy material is determined to be effective (block 310), the advocacy material may be tagged as effective (block 312) and stored, for example in the example database 122 of FIG. 1.

The example method 300 of FIG. 3 determines if the consumer has changed geographic locations (block 314). For example, the example sensor 102 of FIG. 1 may track the consumer's position and detect changes in location. If the consumer has changed location, the second location (e.g., a coffee shop) is identified (block 302) by cross-referencing the geographic location coordinates to a database mapping such coordinates to buildings, businesses, entities, persons, events, e.g., historical events), and the example method 300 continues to match and provide additional advocacy material to the consumer at the second location. If the consumer has not changed location (block 314), the example method 300 determines if additional advocacy materials are to be presented to the consumer at the first location (block 316). If the consumer is to receive further advocacy materials, such advocacy materials are selected (block 306) and control advances to block 308 and subsequent blocks as explained above. If no further materials are to be provided to the consumer (block 316), the example method 300 ends or sits idle (block 318) until additional materials are to be presented or a location change is detected.

FIG. 4 is a block diagram of an example processing platform P100 capable of executing the instructions of FIG. 3 to implement the example system 100, the example sensor 102, the example selector 104, the example display device interface 108, the example data collector 110, the example data collector 201, the example database 122, the example data analyzer 126 and the example accounting module 128. The processor platform P100 can be, for example, a server, a personal computer, or any other type of computing device.

The processor platform P100 of the instant example includes a processor P105. For example, the processor P105 can be implemented by one or more Intel® microprocessors. Of course, other processors from other families are also appropriate.

The processor P105 is in communication with a main memory including a volatile memory P115 and a non-volatile memory P120 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory P120 may be implemented by flash memory and/or any other desired type of memory device. Access to the main memory P115, P120 is typically controlled by a memory controller.

The processor platform P100 also includes an interface circuit P130. The interface circuit P130 may be implemented by any type of past, present or future interface standard, such as an Ethernet interface, a universal serial bus (USB), and/or a PCI express interface.

One or more input devices P135 are connected to the interface circuit P130. The input device(s) P135 permit a consumer to enter data and commands into the processor P105. The input device(s) can be implemented by, for example, a keyboard, a mouse, a touchscreen, a track-pad, a trackball, isopoint and/or a voice recognition system.

One or more output devices P140 are also connected to the interface circuit P130. The output devices P140 can be implemented, for example, by display devices (e.g., a liquid crystal display, and/or a cathode ray tube display (CRT)). The interface circuit P130, thus, typically includes a graphics driver card.

The interface circuit P130 also includes a communication device, such as a modem or network interface card to facilitate exchange of data with external computers via a network (e.g., an Ethernet connection, a digital subscriber line (DSL), a telephone line, coaxial cable, a cellular telephone system, etc.).

The processor platform P100 also includes one or more mass storage devices P150 for storing software and data. Examples of such mass storage devices P150 include floppy disk drives, hard drive disks, compact disk drives and digital versatile disk (DVD) drives.

The coded instructions of FIG. 3 may be stored in the mass storage device P150, in the volatile memory P110, in the non-volatile memory P112, and/or on a removable storage medium such as a CD or DVD.

Although certain example methods, apparatus and properties of manufacture have been disclosed herein, the scope of coverage of this patent is not limited thereto. On the contrary, this patent covers all methods, apparatus and properties of manufacture fairly falling within the scope of the claims of this patent.

What is claimed is:

1. A method comprising:
detecting a location of a consumer;
identifying an advocate in a social network of the consumer, the advocate being a person connected with the consumer in the social network;
selecting advocacy material based on the location and the advocate;
obtaining neuro-response data from the consumer while or after the consumer is exposed to the advocacy material; and
determining an effectiveness of the advocacy material based on the neuro-response data.

2. The method of claim 1 further comprising changing the advocacy material based on the neuro-response data.

3. The method of claim 2, wherein changing the advocacy material includes selecting a new advocate from the social network.

4. The method of claim 1, wherein the advocacy material comprises one or more of an advertisement, an offer, a coupon, a product package, a display, a sign, a recommendation, a testimonial, a quote, or a review.

5. The method of claim 1, wherein the neuro-response data is indicative of one or more of alertness, engagement, attention or resonance.

6. The method of claim 1, wherein the neuro-response data comprises data indicative of an interaction between activity in a first frequency band of a brain of the consumer and activity in a second frequency band different than the first frequency band.

7. The method of claim 1 wherein detecting the location includes collecting location coordinates from one or more of a global positioning system, a wireless internet location service, cellular triangulation or manual entry.

8. The method of claim 1 further comprising compensating the advocate based on the effectiveness.

9. The method of claim 1 further comprising changing the advocacy material based on a change in the location.

10. The method of claim 9 wherein changing the advocacy material occurs in real time.

11. The method of claim 1 wherein the neuro-response data comprises data indicative of activity between two different regions of a brain of the consumer.

12. The method of claim 1 further comprising creating a hierarchy of potential advocates based on the likelihood of influencing the consumer and identifying the advocate based on a hierarchy.

13. A system to provide advocacy materials to a consumer, the system comprising:
a sensor to detect a location of the consumer;
a selector to identify an advocate in a social network of the consumer and to select advocacy material based on the location and the advocate, the advocate being a person connected with the consumer in the social network;
a data collector to obtain neuro-response data from the consumer while or after the consumer is exposed to the advocacy material; and
a data analyzer to determine an effectiveness of the advocacy material based on the neuro-response data.

14. The system of claim 13, wherein the selector is to select a new advocate from the social network to change the advocacy material.

15. The system of claim 13, wherein the advocacy material comprises one or more of an advertisement, an offer, a coupon, a product package, a display, a sign, a recommendation, a testimonial, a quote or a review.

16. The system of claim 13, wherein the neuro-response data comprises data indicative of an interaction between activity in a first frequency band of a brain of the consumer and activity in a second frequency band different than the first frequency band.

17. The system of claim 13 further comprising an accounting tracker to compensate the advocate based on the effectiveness.

18. The system of claim 13, wherein the sensor is located in a mobile device.

19. The system of claim 18, wherein the mobile device is one or more of a mobile telephone or a headset with a plurality of electrodes.

20. The system of claim 13 wherein the selector is to change the advocacy material based on a change in the location.

21. The system of claim 13, wherein the neuro-response data comprises data indicative of activity between two different regions of a brain of the consumer.

22. The system of claim 13, wherein the selector is to create a hierarchy of potential advocates based on the likelihood of influencing the consumer and identify the advocate based on a hierarchy.

23. A tangible machine readable medium storing instructions thereon which, when executed, cause a machine to at least:
detect a location of a consumer;
identify an advocate in a social network of the consumer, the advocate being a person connected with the consumer in the social network;
select advocacy material based on the location and the advocate;
obtain neuro-response data from the consumer while or after the consumer is exposed to the advocacy material; and
determine an effectiveness of the advocacy material based on the neuro-response data.

24. The machine readable medium of claim 21 further causing the machine to change the advocacy material based on one or more of the neuro-response data or a change in the location.

25. A method comprising:
detecting a location of a consumer;
obtaining neuro-response data from the consumer;
identifying an advocate in a social network of the consumer, the advocate being a person connected with the consumer in the social network; and
selecting advocacy material based on the neuro-response data, the location and the advocate.
